(19) United States
(12) Patent Application Publication
(10) Pub. No.: US 2023/0156699 A1
(43) Pub. Date: May 18, 2023

(54) METHOD, DEVICE AND COMPUTER STORAGE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/914,072

(22) PCT Filed: Mar. 25, 2020
(86) PCT No.: PCT/CN2020/081187

§ 371 Date: Sep. 23, 2022

(51) Int. Cl. H04W 72/1273; H04L 1/08

(52) U.S. Cl. CPC H04W 72/1273; H04L 1/08

(57) ABSTRACT

Embodiments of the present disclosure relate to methods, devices and computer storage media for communication. A method comprises transmitting, from a network device to a terminal device, a plurality of PDCCH repetitions for scheduling downlink transmissions, wherein at least a part of the plurality of PDCCH repetitions indicate a same counter downlink assignment indicator (DAI) value; performing, based on the plurality of PDCCH repetitions, the downlink transmissions from the network device to the terminal device; and receiving a feedback sequence for the downlink transmissions from the terminal device, wherein the at least a part of the plurality of PDCCH repetitions correspond to a same feedback field in the feedback sequence. Embodiments of the present disclosure propose a way to indicate DAI values for PDCCH repetitions. The dynamic HARQ-ACK codebook can be obtained based on the DAI values without additional signaling overhead.

### TECHNICAL FIELD

Embodiments of the present disclosure generally relate to the field of telecommunication, and in particular, to methods, devices and computer storage media for communication.

### BACKGROUND

In the 3GPP meeting RAN #86, enhancements on the support for multi-Transmission and Reception Point (multi-TRP) deployment have been discussed. For example, it has been proposed to identify and specify features to improve reliability and robustness for physical channels (such as, Physical Downlink Control Channel (PDCCH), Physical Uplink Shared Channel (PUSCH) and/or Physical Uplink Control Channel (PUCCH)) other than Physical Downlink Shared Channel (PDSCH) using multi-TRP and/or multi-panel with Release 16 reliability features as a baseline. It has also been proposed to identify and specify features to enable inter-cell multi-TRP operations. It has also been proposed to evaluate and specify enhancements for simultaneous multi-TRP transmissions with multi-panel receptions.

In the 3GPP meeting RAN 1#98-99, it has been proposed to support PDCCH repetitions to improve reliability and robustness for the PDCCH. That is, downlink control information (DCI) can be repeatedly transmitted from a network device to a terminal device more than once, so as to improve reliability and robustness for the PDCCH. Typically, a DCI format has a downlink assignment indicator (DAT) field. The values indicated in the DAI field can decide the number and order of bits in a dynamic hybrid automatic repeat request-Acknowledgement (HARQ-ACK) codebook. The so-called HARQ-ACK codebook refers to a feedback sequence generated for downlink transmissions scheduled by DCI. However, if PDCCH repetitions are enabled, how to design the values in the DAI field and how to design the HARQ-ACK codebook have not been specified in the current 3GPP specifications.

### SUMMARY

In general, example embodiments of the present disclosure provide methods, devices and computer storage media for communication.

In a first aspect, there is provided a method of communication. The method comprises transmitting, from a network device to a terminal device, a plurality of PDCCH repetitions for scheduling downlink transmissions, wherein at least a part of the plurality of PDCCH repetitions indicate a same counter downlink assignment indicator (DAI) value; performing, based on the plurality of PDCCH repetitions, the downlink transmissions from the network device to the terminal device; and receiving a feedback sequence for the downlink transmissions from the terminal device, wherein the at least a part of the plurality of PDCCH repetitions correspond to a same feedback field in the feedback sequence.

In a second aspect, there is provided a method of communication. The method comprises receiving, at a terminal device and from a network device, a plurality of PDCCH repetitions for scheduling downlink transmissions, wherein at least a part of the plurality of PDCCH repetitions indicate a same counter downlink assignment indicator (DAI) value; decoding, based on the plurality of PDCCH repetitions, the downlink transmissions from the network device to the terminal device; and transmitting, based on the decoding of the downlink transmissions, a feedback sequence to the network device, wherein the at least a part of the plurality of PDCCH repetitions correspond to a same feedback field in the feedback sequence.

In a third aspect, there is provided a network device. The network device comprises a processor and a memory coupled to the processor. The memory stores instructions that when executed by the processor, cause the network device to perform the method according to the first aspect of the present disclosure.

In a fourth aspect, there is provided a terminal device. The terminal device comprises a processor and a memory coupled to the processor. The memory stores instructions that when executed by the processor, cause the terminal device to perform the method according to the second aspect of the present disclosure.

In a fifth aspect, there is provided a computer readable medium having instructions stored thereon. The instructions, when executed on at least one processor, cause the at least one processor to perform the method according to the above first or second aspect of the present disclosure.

In a sixth aspect, there is provided a computer program product that is stored on a computer readable medium and includes machine-executable instructions. The machine-executable instructions, when being executed, cause a machine to perform the method according to the above first or second aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates a signaling chart of an example process of communication in accordance with some embodiments of the present disclosure;

FIG. 3A-3B illustrate examples of embodiments of the present disclosure;

FIGS. 4A-4C illustrate examples of embodiments of the present disclosure;

FIG. 5 illustrates an example of embodiments of the present disclosure;

FIGS. 6A-6B illustrate examples of embodiments of the present disclosure;

FIGS. 7A-7B illustrate examples of embodiments of the present disclosure;

FIG. 8 illustrates a flowchart of an example method in accordance with some embodiments of the present disclosure;

FIG. 9 illustrates a flowchart of an example method in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ second,′ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As described above, in the 3GPP meeting RAN1 #98-99, it has been proposed to support PDCCH repetitions to improve reliability and robustness for the PDCCH. That is, DCI can be repeatedly transmitted from a network device to a terminal device more than once, so as to improve reliability and robustness for the PDCCH.

Typically, a DCI format has a DAI field. The DAI field may include 2 bits to indicate a counter DAI value and further include 2 bits to indicate a total DAI value. For example, if dynamic HARQ-ACK codebook is configured, the DAI field may only include 2 bits to indicate a counter DAI value. For example, the DCI format may be DCI format 1_0. The counter DAI value in the DCI format denotes the accumulative number of {serving cell, PDCCH monitoring occasion} pair(s) in which PDSCH repetition(s) or Sounding Reference Signal (SRS) PDSCH release associated with the DCI format is present up to the current serving cell and current PDCCH monitoring occasion, first in ascending order of serving cell index and then in ascending order of PDCCH monitoring occasion index. For example, the counter DAI value can be any of {1, 2, 3, 4}. The total DAI value in the DCI format denotes the total number of {serving cell, PDCCH monitoring occasion} pair(s) in which PDSCH repetition(s) or SRS PDSCH release associated with the DCI format is present up to the current PDCCH monitoring occasion and is updated from PDCCH monitoring occasion to PDCCH monitoring occasion. For example, the total DAI value can be any of {1, 2, 3, 4}.

The total DAI value and the counter DAI value indicated in the DAI field of DCI can decide the number and order of bits in a dynamic HARQ-ACK codebook. The so-called HARQ-ACK codebook refers to a feedback sequence generated for downlink transmissions scheduled by DCI. However, if PDCCH repetitions are enabled, how to design the values in the DAI field and how to design the HARQ-ACK codebook have not been specified in the current 3GPP specifications.

Embodiments of the present disclosure provide a solution to solve the above problem and/or one or more of other potential problems. This solution proposes a way to indicate the total DAI value and the counter DAI value in the DAI field for each of the PDCCH repetitions. The dynamic HARQ-ACK codebook can be obtained based on the total DAI value and the counter DAI value indicated in the DAI field, without additional signaling overhead. In the following, the terms “PDCCH repetitions”, “repeated PDCCHs” and “repeated PDCCH signals” can be used interchangeably. The terms “feedback sequence”, “feedback codebook”, “HARQ-ACK codebook” and “codebook” can be used interchangeably.

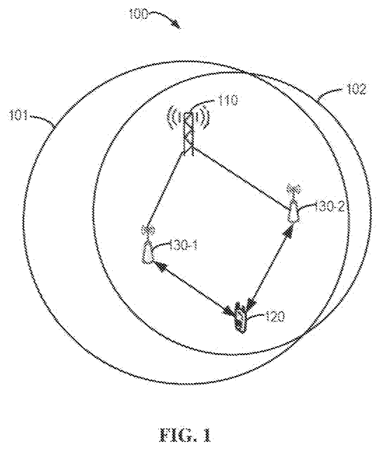

FIG. 1 shows an example communication network 100 in which embodiments of the present disclosure can be implemented. The network 100 includes a network device 110 and a terminal device 120 served by the network device 110. The network 100 may provide one or more serving cells to serve the terminal device 120. Carrier Aggregation (CA) can be supported in the network 100, in which two or more CCs are aggregated in order to support a broader bandwidth. For example, in FIG. 1, the network device 110 may provide to the terminal device 120 a plurality of serving cells including one primary cell (Pcell) 101 corresponding to a primary CC and at least one secondary cell (Scell) 102 corresponding to at least one secondary CC. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

In some embodiments, for downlink transmissions, the network device 110 may transmit control information via a PDCCH and/or transmit data via a PDSCH to the terminal device 120. Additionally, the network device 110 may transmit one or more reference signals (RSs) to the terminal device 120. The RS transmitted from the network device 110 to the terminal device 120 may also referred to as a “DL RS”. Examples of the DL RS may include but are not limited to Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

In some embodiments, for uplink transmissions, the terminal device 120 may transmit control information via a PUCCH and/or transmit data via a PUSCH to the network device 110. Additionally, the terminal device 120 may transmit one or more RSs to the network device 110. The RS transmitted from the terminal device 120 to the network device 110 may also referred to as a “UL RS”. Examples of the UL RS may include but are not limited to DMRS, CSI-RS, SRS, PTRS, fine time and frequency TRS and so on.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The network device 110 (such as, a gNB) may be equipped with one or more TRPs or antenna panels. As used herein, the term “TRP” refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As shown in FIG. 1, for example, the network device 110 may communicate with the terminal device 120 via TRPs 130-1 and 130-2. In the following text, the TRP 130-1 may be also referred to as the first TRP, while the TRP 130-2 may be also referred to as the second TRP. The first and second TRPs 130-1 and 130-2 may be included in same serving cells (such as, the serving cells 101 and 102 as shown in FIG. 1) or different serving cells provided by the network device 110. Although some embodiments of the present disclosure are described with reference to the first and second TRPs 130-1 and 130-2 within same serving cells provided by the network device 110, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

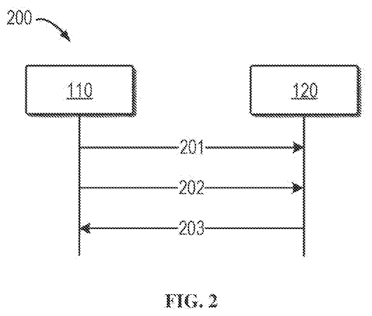

FIG. 2 illustrates a signaling chart of an example process 200 of communication in accordance with some embodiments of the present disclosure. The process 200 involves the network device 110 and the terminal device 120 as shown in FIG. 1 and/or FIG. 1B.

As shown in FIG. 2, the network device 110 may transmit (201) a plurality of PDCCH repetitions for scheduling downlink transmissions (such as, PDSCH transmissions related to same data or a same transport block) to the terminal device 120. In some embodiments, at least a part of the plurality of PDCCH repetitions may share a same counter DAI value. The terminal device 120 may receive (201) the plurality of PDCCH repetitions from the network device 110. For example, none or at least one of the plurality of PDCCH repetitions may be received by the terminal device 120. The network device 110 may perform (202) the downlink transmissions to the terminal device 120 based on the plurality of PDCCH repetitions. The terminal device 120 may decode (202) the downlink transmissions from the network device 110 and transmit (203), based on the decoding of the downlink transmissions, a feedback sequence for the downlink transmissions to the network device 110. In some embodiments, the at least a part of the plurality of PDCCH repetitions sharing the same counter DAI value may correspond to a same feedback field (such as, one bit or two bits) in the feedback sequence (that is, the HARQ-ACK codebook). For example, if at least one of downlink transmissions scheduled by the at least a part of the plurality of PDCCH repetitions is decoded by the terminal device 120 successfully, the terminal device 120 may indicate an acknowledgement (ACK) in the feedback field. If none of downlink transmissions scheduled by the at least a part of the plurality of PDCCH repetitions is decoded by the terminal device 120 successfully, the terminal device 120 may indicate a negative acknowledgement (NACK) in the feedback field. The network device 110 may receive (203) the feedback sequence for the downlink transmissions from the terminal device 120.

In some embodiments, the network device 110 may indicate a same counter DAI value in PDCCH repetitions. This may implicitly indicate that these PDCCH repetitions sharing the same counter DAI value are used for scheduling downlink transmissions related to same data or same TB(s). In some embodiments, if the terminal device 120 detects a same counter DAI value in different PDCCH signals, for example, received in same or different PDCCH monitoring occasions, the terminal device 120 may determine that these PDCCH signals sharing the same counter DAI value are PDCCH repetitions for scheduling downlink transmissions related to same data or same TB(s). The terminal device 120 may further determine that these PDCCH repetitions correspond to a same feedback field (such as, one bit or two bits) in the feedback sequence (such as, the HARQ-ACK codebook).

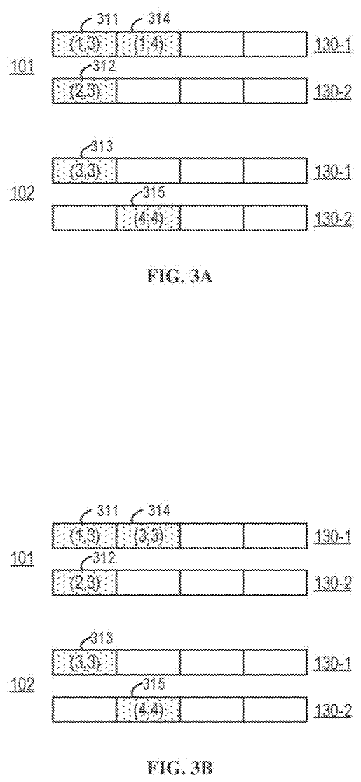

FIG. 3A illustrates an example of such embodiments. FIG. 3A shows PDCCH signals 311, 312 . . . 315. Each of the PDCCH signals 311, 312 . . . 315 indicates a pair of counter DAI value c and total DAI value t, represented as (c, t), where c and t are both integers, for example, 1≤c≤4 and 1≤t≤4. As shown in FIG. 3A, the PDCCH signals 311 and 314 are transmitted via the TRP 130-1 in the serving cell 101. The PDCCH signals 311 and 314 may be associated with a control resource set (CORESET) with a value of 0 configured for CORESETPoolIndex, or associated with a CORESET without CORESETPoolIndex configured. The PDCCH signal 312 is transmitted via the TRP 130-2 in the serving cell 101. The PDCCH signal 312 may be associated with a CORESET with a value of 1 configured for CORESETPoolIndex. The PDCCH signal 313 is transmitted via the TRP 130-1 in the serving cell 102. The PDCCH signal 313 may be associated with a CORESET with a value of 0 configured for CORESETPoolIndex, or associated with a CORESET without CORESETPoolIndex configured. The PDCCH signal 315 is transmitted via the TRP 130-2 in the serving cell 102. The PDCCH signal 315 may be associated with a CORESET with a value of 0 configured for CORESETPoolIndex, or associated with a CORESET without CORESETPoolIndex configured. For example, in FIG. 3A, the PDCCH signals 311 and 314 are PDCCH repetitions, which share a same counter DAI value and correspond to a same bit in the feedback sequence (such as, the HARQ-ACK codebook).

In some embodiments, counter DAI values and/or total DAI values for non-repeated PDCCH signals 312, 313 and 315 can be determined as legacy solutions. For example, the counter DAI value in a DCI format denotes the accumulative number of {serving cell, PDCCH monitoring occasion} pair(s) in which PDSCH repetition(s) or SRS PDSCH release associated with the DCI format is present up to the current serving cell and current PDCCH monitoring occasion, first in ascending order of serving cell index and then in ascending order of PDCCH monitoring occasion index. For another example, for an active downlink (DL) bandwidth part (BWP) of a serving cell, if a terminal device is provided with CORESETPoolIndex of a value 0 for one or more first control resource sets (CORESETs) and is provided with CORESETPoolIndex of a value 1 for one or more second CORESETs, and if the terminal device is provided with ACKNACKFeedbackMode equaling to JointFeedback, the serving cell may be counted two times in which the first time corresponds to the first CORESETs and the second time corresponds to the second CORESETs. The total DAI value in the DCI format denotes the total number of {serving cell, PDCCH monitoring occasion} pair(s) in which PDSCH repetition(s) or SRS PDSCH release associated with the DCI format is present up to the current PDCCH monitoring occasion and is updated from PDCCH monitoring occasion to PDCCH monitoring occasion.

In some embodiments, PDCCH monitoring occasions occupied by PDCCH repetitions may be counted only once into the total DAI value. For example, as shown in FIG. 3A, although total 5 PDCCH monitoring occasions are occupied by PDCCH signals, the maximum total DAI value is 4 instead of 5, since the 2 PDCCH monitoring occasions occupied by the PDCCH repetitions 311 and 314 are counted only once into the total DAI value.

In some embodiments, the total DAI field in a DCI format may include Nₜ bits, where Nₜ is a non-negative integer. For example, Nₜ may be any of {1, 2, 3, 4, 5}. In some embodiments, the counter DAI field in the DCI format may include N_{c} bits, where N_{c} is a non-negative integer. For example, N_{c} may be any of {1, 2, 3, 4, 5}. In some embodiments, there may be Mₜ candidate/available values for the total DAI field, where Mₜ is a non-negative integer. For example, Mₜ may be any of {1, 2, 4, 6, 8, 10, 12, 16, 24, 32}. In some embodiments, there may be M_{c} candidate/available values for the counter DAI field, where M_{c} is a non-negative integer. For example, M_{c} may be any of {1, 2, 4, 6, 8, 10, 12, 16, 24, 32}. In some embodiments, the available values for total DAI may be consecutive integers, which may be represented as {1, 2, 3 . . . Pₜ}, where Pₜ is a positive integer. For example, Pₜ may be any of {1, 2, 4, 6, 8, 10, 12, 16, 24, 32}. In some embodiments, the available values for counter DAI may be consecutive integers, which may be represented as {1, 2, 3 . . . P_{c}}, where P_{c} is a positive integer. For example, P_{c} may be any of {1, 2, 4, 6, 8, 10, 12, 16, 24, 32}.

In some embodiments, a set of PDCCH monitoring occasions for a DCI format scheduling PDSCH receptions or semi-persistent Sounding Reference Signal (SPS) PDSCH release is defined as the union of PDCCH monitoring occasions across active DL BWPs of configured serving cells. In some embodiments, the feedbacks of HARQ-ACK codebook for the PDSCH receptions or SPS PDSCH release scheduled by the set of PDCCH monitoring occasions are in a same slot. In some embodiments, the values of counter DAI (for example, the counter DAI value can be represented as V_{c}, where V is a positive integer, and 1≤V_{c}≤P_{c}) for the PDCCHs in the set of PDCCH monitoring occasions may be accumulated or indexed one by one. If the value of counter DAI V_{c} reaches P_{c}, it will be indexed starting from 1. In some embodiments, the values of total DAI (for example, the total DAI value can be represented as Vₜ, where Vₜ is a positive integer, and 1≤Vₜ≤Pₜ) for the PDCCHs in the set of PDCCH monitoring occasions are accumulated or indexed one by one. If the value of total DAI Vₜ reaches Pₜ, it will be indexed starting from 1. The index of a PDCCH in the set of PDCCH monitoring occasions may be represented as X, where X is a positive integer, for example, 1≤X≤64. In some embodiments, the value of total DAI for the PDCCH in the set of PDCCH monitoring occasions may be Vₜ=(X−1) mod Pₜ+1. In some embodiments, the value of counter DAI for the PDCCH in the set of PDCCH monitoring occasions may be V_{c}=(X−1) mod P_{c}+1. In some embodiments, the counter DAI value may increase monotonically with PDCCHs and may return to 1 after reaching the maximum value for counter DAI. As such, a set of counter DAI values may be represented as {1, 2, 3, . . . Y_{c}}, where Y_{c} is a positive integer and 1≤Y_{c}≤P_{c} and P_{c} represents the maximum value for counter DAI. For example, if the counter DAI value for a current PDCCH is V_{c}, where V_{c}=P_{c}, the counter DAI value for a next PDCCH will return to 1. The counter DAI values for the current PDCCH and the next PDCCH belong to two different sets. In some embodiments, the total DAI value may increase monotonically and may return to 1 after reaching the maximum value for total DAI. As such, a set of total DAI values may be represented as {1, 2, 3, . . . Yₜ}, where Yₜ is a positive integer and 1≤Yₜ≤Pₜ and Pₜ represents the maximum value for total DAI. For example, if the total DAI value for a current PDCCH is Vₜ, where Vₜ=Pₜ, the total DAI value for a next PDCCH will return to 1. The total DAI values for the current PDCCH and the next PDCCH belong to two different sets.

In some embodiments, the terminal device 120 may be configured/indicated with F repeated PDCCHs in the set of PDCCH monitoring occasions, where F is a positive integer and 1<F≤32. For example, F may be one of {2, 4, 6, 8, 10, 12, 16, 32}. In some embodiments, the F PDCCHs may be countered or accumulated only once for the counter DAI value and/or the total DAI value. In some embodiments, each of the F PDCCHs may be countered into the value of total DAI. In some embodiments, the counter DAI value and/or the total DAI value may be determined based on PDCCHs for different data or TB(s) scheduling. In some embodiments, only the first or last candidate or potential PDCCH repetition may be countered into the counter DAI value and/or the total DAI value. For the other candidate or potential PDCCH repetitions, the counter DAI value and/or the total DAI value may be the same as those in the PDCCH in the previous and/or next PDCCH monitoring occasion.

FIG. 3B illustrates an example of such embodiments. FIG. 3B shows PDCCH signals 311, 312 . . . 315. Each of the PDCCH signals 311, 312 . . . 315 indicates a pair of counter DAI value c and total DAI value t, represented as (c, t), where c and t are both integers, for example, 1≤c≤4 and 1≤t≤4. As shown in FIG. 3B, the PDCCH signals 311 and 314 are transmitted via the TRP 130-1 in the serving cell 101. The PDCCH signals 311 and 314 are transmitted via the TRP 130-1 may be associated with a control resource set (CORESET) with a value of 0 configured for CORESETPoolIndex, or associated with a CORESET without CORESETPoolIndex configured. The PDCCH signal 312 is transmitted via the TRP 130-2 in the serving cell 101. The PDCCH signal 312 may be associated with a CORESET with a value of 1 configured for CORESETPoolIndex. The PDCCH signal 313 is transmitted via the TRP 130-1 in the serving cell 102. The PDCCH signal 313 may be associated with a CORESET with a value of 0 configured for CORESETPoolIndex, or associated with a CORESET without CORESETPoolIndex configured. The PDCCH signal 315 is transmitted via the TRP 130-2 in the serving cell 102. The PDCCH signal 315 may be associated with a CORESET with a value of 0 configured for CORESETPoolIndex, or associated with a CORESET without CORESETPoolIndex configured. For example, in FIG. 3B, the PDCCH signals 311 and 314 are PDCCH repetitions. Therefore, only the PDCCH signal 311 is countered into the counter DAI value and the total DAI value, while the counter DAI value and the total DAI value for the PDCCH signal 314 are the same as those for the PDCCH signal 313, which is the previous PDCCH in the previous PDCCH monitoring occasion.

In some embodiments, the network device 110 may transmit, to the terminal device 120, a configuration indicative of whether PDCCH signals sharing a same counter DAI value across different sets of total DAI values are repeated or not. Alternatively, or in addition, in some embodiments, the network device 110 may transmit, to the terminal device 120, a configuration indicative of at least one of the following: whether PDCCHs are repeated or not, time and/or frequency resources for candidate PDCCH repetitions, a duration for the candidate PDCCH repetitions, the number of candidate PDCCH repetitions, and respective indices of the candidate PDCCH repetitions. In some embodiments, the configuration may be transmitted to the terminal device 120 via explicit signaling or implicit signaling. The explicit signaling may include any of Radio Resource Control (RRC) signaling, Medium Access Control (MAC) control element (CE) and DCI. In some embodiments, the configuration can be implicitly indicated via DCI. For example, if PDCCH signals sharing a same counter DAI value across different sets of total DAI values indicate same time and/or frequency resource allocation, or if PDCCH signals sharing a same counter DAI value across different sets of total DAI values have same values in fields other than the DAI field, these PDCCH signals can be regarded as PDCCH repetitions. For example, the fields other than the DAI field may include at least one of carrier indicator field, bandwidth part indicator field, frequency domain resource allocation field, time domain resource allocation field, physical resource block (PRB) bundling size indicator field, rate matching indicator field, virtual resource block (VRB) to PRB mapping field, zero power (ZP) CSI-RS trigger field, modulation and coding scheme and new data indicator and redundancy version field for transport block 1 and/or 2, HARQ process number field, transmit power control (TPC) command for PUSCH and/or PUCCH field, PDSCH-to-HARQ feedback timing indicator field, antenna port(s) field, transmission configuration indication (TCI) field, SRS request field, code block group (CBG) transmission information (CBGTI) field, CBG flushing out information (CBGFI) field and DMRS sequence initialization field.

In some embodiments, if the terminal device 120 is indicated that PDCCH signals sharing a same counter DAI value across different sets of total DAI values are PDCCH repetitions, the terminal device 120 may determine that PDCCH signals sharing a same counter DAI value across different sets of total DAI values are PDCCH repetitions and these PDCCH repetitions correspond to a same feedback field (such as, one bit or two bits) in the feedback sequence.

In some embodiments, if the terminal device 120 is indicated that a set of PDCCHs are repeated, it can be determined that the values of counter DAI in the repeated PDCCHs are the same, and/or the values of total DAI in the repeated PDCCHs are the same. In some embodiments, if the terminal device 120 is indicated that a set of PDCCHs are repeated, it can be determined that the values of counter DAI within a same set of counter DAI values are the same for the repeated PDCCHs. In some embodiments, if the terminal device 120 is indicated that a set of PDCCHs are repeated, it can be determined that the values of total DAI within a same set of total DAI values are the same for the repeated PDCCHs.

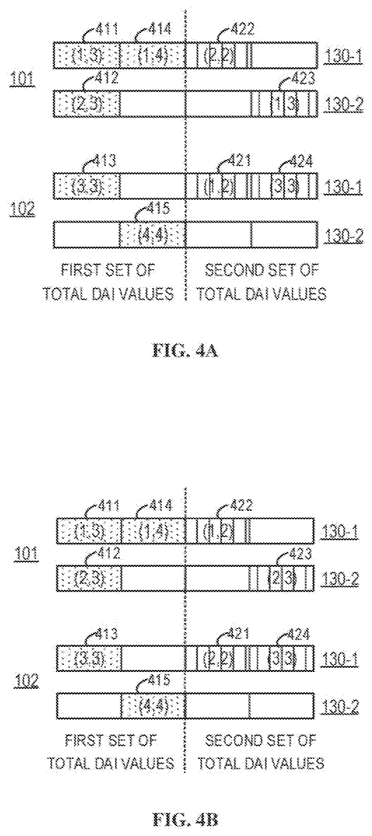

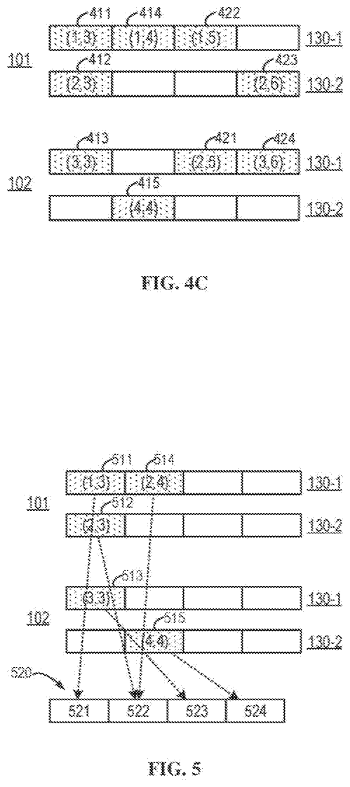

FIG. 4A illustrates an example of such embodiments. FIG. 4A shows PDCCH signals 411, 412 . . . 415 indicating a first set of total DAI values and PDCCH signals 421, 422 . . . 424 indicating a second set of total DAI values. Each of the PDCCH signals 411, 412 . . . 415 and 421, 422 . . . 424 indicates a pair of counter DAI value c and total DAI value t, represented as (c, t), where c and t are both integers, for example, 1≤c≤4 and 1≤t≤4. As shown in FIG. 4A, the PDCCH signals 411, 414 and 422 are transmitted via the TRP 130-1 in the serving cell 101. The PDCCH signals 411, 414 and 422 may be may be associated with a CORESET with a value of 0 configured for CORESETPoolIndex, or associated with a CORESET without CORESETPoolIndex configured. The PDCCH signals 412 and 423 are transmitted via the TRP 130-2 in the serving cell 101. The PDCCH signals 412 and 423 may be associated with a CORESET with a value of 1 configured for CORESETPoolIndex. The PDCCH signals 413, 421 and 424 are transmitted via the TRP 130-1 in the serving cell 102. The PDCCH signals 413, 421 and 424 may be associated with a CORESET with a value of 0 configured for CORESETPoolIndex, or associated with a CORESET without CORESETPoolIndex configured. The PDCCH signal 415 is transmitted via the TRP 130-2 in the serving cell 102. The PDCCH signal 415 may be associated with a CORESET with a value of 0 configured for CORESETPoolIndex, or associated with a CORESET without CORESETPoolIndex configured. The PDCCH signals 411, 414, 421 and 423 are PDCCH repetitions, which share a same counter DAI value and correspond to a same bit in the feedback sequence (that is, the HARQ-ACK codebook). In some embodiments, counter DAI values and/or total DAI values for non-repeated PDCCH signals can be determined as legacy solutions. In some embodiments, in each set of total DAI values, PDCCH monitoring occasions occupied by PDCCH repetitions may be counted only once into the total DAI value. For example, as shown in FIG. 4A, regarding the first set of total DAI values, although total 5 PDCCH monitoring occasions are occupied, the maximum total DAI value is 4 instead of 5, since 2 PDCCH monitoring occasions occupied by the PDCCH repetitions 411 and 414 are counted only once into the total DAI value. Regarding the second set of total DAI values, although total 4 PDCCH monitoring occasions are occupied, the maximum total DAI value is 3 instead of 4, since 2 PDCCH monitoring occasions occupied by the PDCCH repetitions 421 and 423 are counted only once into the total DAI value.

Alternatively, in some embodiments, PDCCH signals across different sets of total DAI values may have independent counter DAI values. That is, the terminal device 120 may determine that PDCCH signals sharing a same counter DAI value in a same set of total DAI values are PDCCH repetitions and these PDCCH repetitions correspond to a same feedback field (such as, one bit or two bits) in the feedback sequence (such as, the HARQ-ACK codebook). The terminal device 120 may assume that two PDCCH signals sharing a same counter DAI value across two different sets of total DAI values are not PDCCH repetitions and they correspond to different feedback fields in the feedback sequence (such as, the HARQ-ACK codebook).

FIG. 4B illustrates an example of such embodiments. Similar to FIG. 4A, FIG. 4B shows the PDCCH signals 411, 412 . . . 415 indicating a first set of total DAI values and PDCCH signals 421, 422 . . . 424 indicating a second set of total DAI values. Different from FIG. 4A, counter DAI values for the PDCCH signals 411, 412 . . . 415 are independent of counter DAI values for the PDCCH signals 421, 422 . . . 424. As shown in FIG. 4B, the PDCCH signals 411 and 414 corresponding to the first set of total DAI values are PDCCH repetitions, which share a same counter DAI value and correspond to one bit or two bits in the feedback sequence (that is, the HARQ-ACK codebook). The PDCCH signals 421 and 423 are PDCCH repetitions, which share a same counter DAI value and correspond to another bit in the feedback sequence (that is, the HARQ-ACK codebook). Counter DAI values and/or total DAI values for non-repeated PDCCH signals can be determined as legacy solutions, which will not be repeated here.

As described above, in the legacy solutions, the total DAI value are indicated in 2 bits. That is, the total DAI value can be any of {1, 2, 3, 4}. In some embodiments, more bits (such as, 3 or 4 bits) can be used to indicate the total DAI value in the DAI field. For example, if 3 bits are used to indicate the total DAI value, the maximum total DAI value can be up to A₃. For example, the total DAI values may be {1, 2, 3, 4, . . . A₃}, where A₃ is a positive integer, and 4<A₃≤8. If 4 bits are used to indicate the total DAI value, the maximum total DAI value can be up to A₄. For example, the total DAI values may be {1, 2, 3, 4, . . . A₄}, where A₄ is a positive integer, and 8<A₃≤16. In some embodiments, the total DAI values for the PDCCHs in the set of PDCCH monitoring occasions may be monotonically increasing or may be included in a single set of total DAI values. As such, the plurality of PDCCH repetitions transmitted from the network device 110 to the terminal device 120 can correspond to a single set of total DAI values. That is, the plurality of PDCCH repetitions may indicate different total DAI values respectively.

FIG. 4C illustrates an example of such embodiments. Different from FIGS. 4A and 4B, in FIG. 4C, the PDCCH signals 411, 412 . . . 415 and 421, 422 . . . 424 correspond to s single set of total DAI values. For example, the PDCCH signals 411, 414, 421 and 423 are PDCCH repetitions, which correspond to a same bit in the feedback sequence (that is, the HARQ-ACK codebook). Some of the PDCCH repetitions may share a same counter DAI value. For example, the PDCCH repetitions 411 and 414 share a first counter DAI value (that is, 1), and the PDCCH repetitions 421 and 423 share a second counter DAI value (that is, 2). Counter DAI values and/or total DAI values for non-repeated PDCCH signals can be determined as legacy solutions, which will not be repeated here.

In some embodiments, the number and order of bits of the feedback sequence (that is, the HARQ-ACK codebook) can be determined based on counter DAI values and/or total DAI values indicated in respective DAI fields of PDCCH signals. In some embodiments, the terminal device 120 is configured/indicated with F repeated PDCCHs, where F is a positive integer, and 1<F≤32. For example, F may be one of {2, 4, 6, 8, 10, 12, 16, 32}. For example, the F PDCCH repetitions for scheduling downlink transmissions are related to same data or same TB(s). For each downlink transmission (for example, PDSCH transmission), there may be one HARQ-ACK feedback field (such as, one bit or two bits), which is coded or located in the feedback sequence or the HARQ-ACK codebook. For example, there may be an index or a position for the HARQ-ACK feedback field in the feedback sequence and/or codebook. In addition, may be G PDCCH repetitions (where G is a positive integer and 1<G≤F) within the F repeated PDCCHs. In some embodiments, the HARQ-ACK feedback field for the downlink transmissions scheduled by the G PDCCH repetitions may be the same. For example, there may be only one HARQ-ACK feedback field for the downlink transmissions scheduled by the G PDCCH repetitions. For another example, the index and/or the position of the HARQ-ACK feedback field in the feedback sequence for the downlink transmissions scheduled by the G PDCCH repetitions may be the same. In some embodiments, if the terminal device 120 detects a same counter DAI value in different PDCCH signals, for example, received in same or different PDCCH monitoring occasions, the terminal device 120 may determine that these PDCCH signals sharing the same counter DAI values are PDCCH repetitions for scheduling downlink transmissions related to same data or same TB(s) and these PDCCH repetitions correspond to a same feedback field (such as, one bit or two bits) in the feedback sequence (that is, the HARQ-ACK codebook).

In some embodiments, the terminal device 120 may be configured/indicated with F repeated PDCCHs, where F is a positive integer, and 1<F≤32. For example, F may be one of {2, 4, 6, 8, 10, 12, 16, 32}. There may be G PDCCH repetitions (where G is a positive integer and 1<G≤F) within the F repeated PDCCHs. If the time and/or frequency resources for the G PDCCH repetitions are multiplexed in frequency domain or based on Frequency Division Multiplexing (FDM), or if the start times of search space sets for the G PDCCH repetitions are same, the counter DAI values and/or the total DAI values in the G PDCCH repetitions are the same.

FIG. 5 illustrates an example of such embodiments. FIG. 5 shows PDCCH signals 511, 512 . . . 515 and a feedback sequence 520 (that is, a HARQ-ACK codebook) generated for PDSCH transmissions scheduled by the PDCCH signals 511, 512 . . . 515. As shown in FIG. 5, each of the PDCCH signals 511, 512 . . . 515 indicates a pair of counter DAI value c and total DAI value t, represented as (c, t), where c and t are both integers, 1<c≤4 and 1≤t≤4. The PDCCH signals 511 and 514 are transmitted via the TRP 130-1 in the serving cell 101. The PDCCH signals 511 and 514 may be associated with a control resource set (CORESET) with a value of 0 configured for CORESETPoolIndex, or associated with a CORESET without CORESETPoolIndex configured. The PDCCH signal 512 is transmitted via the TRP 130-2 in the serving cell 101. The PDCCH signal 512 may be associated with a CORESET with a value of 1 configured for CORESETPoolIndex. The PDCCH signal 513 is transmitted via the TRP 130-1 in the serving cell 102. The PDCCH signal 513 may be may be associated with a CORESET with a value of 0 configured for CORESETPoolIndex, or associated with a CORESET without CORESETPoolIndex configured. The PDCCH signal 515 is transmitted via the TRP 130-2 in the serving cell 102. The PDCCH signal 515 may be associated with a CORESET with a value of 0 configured for CORESETPoolIndex, or associated with a CORESET without CORESETPoolIndex configured. The PDCCH signals 512 and 514 are PDCCH repetitions, which share a same counter DAI value. Counter DAI values and/or total DAI values for non-repeated PDCCH signals can be determined as legacy solutions. The number and order of bits of the feedback sequence 520 can be determined based on counter DAI values and/or total DAI values indicated in respective PDCCH signals 511, 512 . . . 515. As shown in FIG. 5, the feedback sequence 520 includes 4 feedback fields 521, 522, 523 and 524. For example, each feedback filed includes one bit or two bits. The PDCCH signal 511 corresponds to the feedback field 521. That is, if the terminal device 120 successfully decodes a PDSCH transmission scheduled by the PDCCH signal 511, the terminal device may indicate an ACK in the feedback field 521; otherwise, the terminal device may indicate a NACK in the feedback field 521. The PDCCH repetitions 512 and 514 correspond to the feedback field 522. That is, if at least one of PDSCH transmission(s) scheduled by the PDCCH repetitions 512 and 514 is decoded by the terminal device 120 successfully, the terminal device may indicate an ACK in the feedback field 522. If none of PDSCH transmission(s) scheduled by the PDCCH repetitions 512 and 514 is decoded by the terminal device 120 successfully, the terminal device may indicate a NACK in the feedback field 522. Similarly, the PDCCH signal 513 corresponds to the feedback field 523 and the PDCCH signal 515 corresponds to the feedback field 524.

In some embodiments, the number and order of bits of the feedback sequence (that is, the HARQ-ACK codebook) can be determined based on counter DAI values and/or total DAI values indicated in respective DAI fields of PDCCH signals. In some embodiments, if the terminal device 120 detects a same counter DAI value in different PDCCH signals, for example, received in same or different PDCCH monitoring occasions, the terminal device 120 may determine that these PDCCH signals sharing the same counter DAI values are PDCCH repetitions for scheduling downlink transmissions related to same data or same TB(s) and these PDCCH repetitions correspond to a same feedback field (such as, one bit or two bits) in the feedback sequence. The feedback field corresponding to the PDSCH or SPS release scheduled by the PDCCH repetitions may be located in a fixed position in the feedback sequence. In some embodiments, if the terminal device 120 detects PDCCH signals sharing a same counter DAI value across different sets of total DAI values (such as, a first set of total DAI values and a second set of total DAI values), the terminal device 120 may determine that the PDCCH signals are PDCCH repetitions and these PDCCH repetitions correspond to a same feedback field (such as, one bit or two bits) in the feedback sequence. The location of the feedback field corresponding to these PDSCH or SPS PDSCH release scheduled by the PDCCH repetitions in the feedback sequence may be associated with the first set of total DAI values or the second or last set of total DAI values.

In some embodiments, the terminal device 120 may be configured/indicated with at least one of the following: a starting position, an ending position, a duration/range, a periodicity, an offset in time and/or frequency domain, and/or respective indices for a set of PDCCH candidate/potential repetitions. For example, the starting or ending position may indicate at least one of a symbol index, a slot index, a subframe index and/or a frame index. In some embodiments, the location of the feedback field corresponding to the PDSCH or SPS release scheduled by the PDCCH repetitions in the feedback sequence may be associated with the counter DAI value and/or the total DAI value in the first PDCCH repetition, and/or may be associated with the counter DAI value and/or the total DAI value in the last PDCCH repetition.

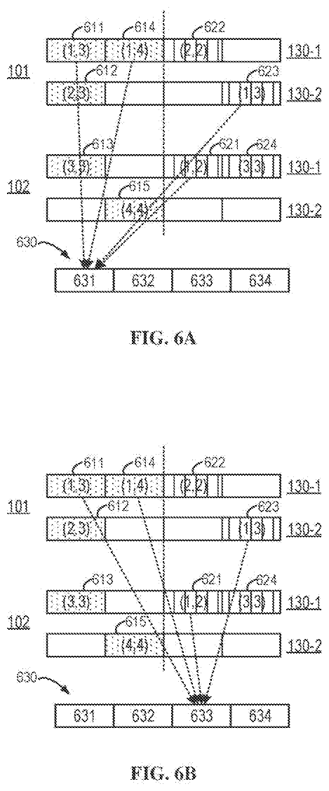

FIGS. 6A and 6B illustrate examples of such embodiments. FIGS. 6A and 6B show PDCCH signals 611, 612 . . . 615 indicating a first set of total DAI values and PDCCH signals 621, 622 . . . 624 indicating a second set of total DAI values. Each of the PDCCH signals 611, 612 . . . 615 and 621, 622 . . . 624 indicates a pair of counter DAI value c and total DAI value t, represented as (c, t), where c and t are both integers, for example, 1≤c≤4 and 1≤t≤4. The PDCCH signals 611, 614 and 622 are transmitted via the TRP 130-1 in the serving cell 101. The PDCCH signals 611, 614 and 622 may be associated with a CORESET with a value of 0 configured for CORESETPoolIndex, or associated with a CORESET without CORESETPoolIndex configured. The PDCCH signals 612 and 623 are transmitted via the TRP 130-2 in the serving cell 101. The PDCCH signals 612 and 623 may be associated with a CORESET with a value of 1 configured for CORESETPoolIndex. The PDCCH signals 613, 621 and 624 are transmitted via the TRP 130-1 in the serving cell 102. The PDCCH signals 613, 621 and 624 may be associated with a CORESET with a value of 0 configured for CORESETPoolIndex, or associated with a CORESET without CORESETPoolIndex configured. The PDCCH signal 615 is transmitted via the TRP 130-2 in the serving cell 102. The PDCCH signal 615 may be associated with a CORESET with a value of 0 configured for CORESETPoolIndex, or associated with a CORESET without CORESETPoolIndex configured. FIGS. 6A and 6B also show a feedback sequence 630 (that is, a HARQ-ACK codebook) generated for PDSCH transmissions scheduled by the PDCCH signals. For example, the feedback sequence 630 includes 4 feedback fields 631, 632, 633 and 634. The PDCCH signals 611, 614, 621 and 623 are PDCCH repetitions, which share a same counter DAI value and correspond to a same feedback field in the feedback sequence (that is, the HARQ-ACK codebook). In some embodiments, the feedback field corresponding to the PDSCH or SPS release scheduled by the PDCCH repetitions 611, 614, 621 and 623 may be associated with the first set of total DAI values and depend on the counter DAI value indicated in the PDCCH repetition 611, as shown by the feedback field 631 in FIG. 6A. Alternatively, in other embodiments, the feedback field corresponding to the PDSCH or SPS release scheduled by the PDCCH repetitions 611, 614, 621 and 623 may be associated with the second set of total DAI values and depend on the counter DAI value indicated in the PDCCH repetition 623, as shown by the feedback field 633 in in FIG. 6B.

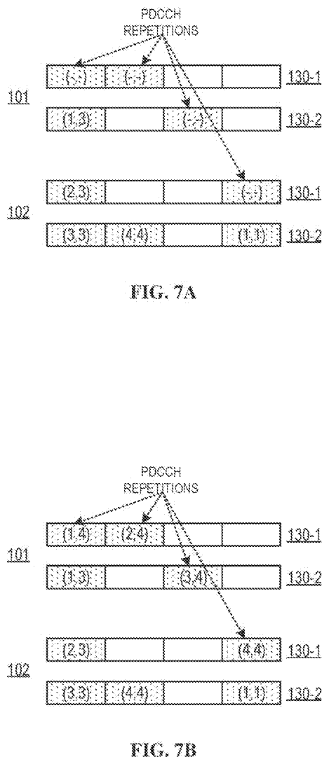

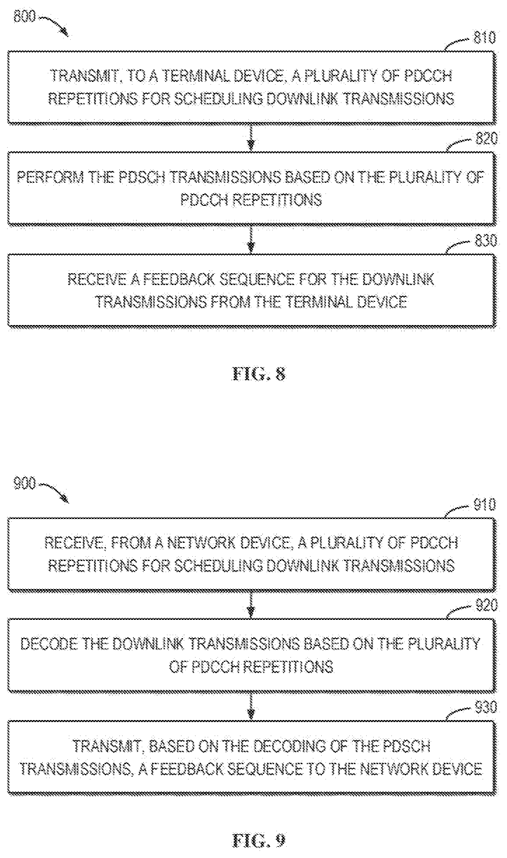

In some embodiments, if PDCCH repetitions are enabled, counter DAI values and/or total DAI values for the PDCCH repetitions can be decided separately from non-repeated PDCCH signals. For example, counter DAI values and/or total DAI values for non-repeated PDCCH signals can be determined as legacy solutions, which will not be repeated here. Regarding the PDCCH repetitions, the DAI fields can be omitted or ignored. FIG. 7A illustrates an example of such embodiments. As shown in FIG. 7A, the DAI fields in PDCCH repetitions can be omitted or ignored, represented as (-,-). Counter DAI values and/or total DAI values for non-repeated PDCCH signals can be determined as legacy solutions.

In some embodiments, if PDCCH repetitions are enabled, counter DAI values and/or total DAI values for the PDCCH repetitions can be decided separately from non-repeated PDCCH signals. For example, counter DAI values and/or total DAI values for non-repeated PDCCH signals can be determined as legacy solutions, which will not be repeated here. Regarding the PDCCH repetitions, the DAI fields can be reused to indicate other information. FIG. 7B illustrates an example of such embodiments. As shown in FIG. 7B, the DAI field in one of PDCCH repetitions can be reused to indicate an index of the PDCCH repetition within the PDCCH repetitions and/or the total number of the PDCCH repetitions. Counter DAI values and/or total DAI values for non-repeated PDCCH signals can be determined as legacy solutions.

In some embodiments, the terminal device 120 may be configured/indicated with a set of PDCCH repetitions. There may be a parameter associated with the PDCCH repetitions and/or indicated in the PDCCH repetitions. For example, the parameter may be used to indicate an order and/or a position of the feedback field (such as, one bit or two bits) in the feedback sequence (that is, the HARQ-ACK codebook). The feedback field includes a HARQ-ACK feedback for the PDSCH or SPS PDSCH release scheduled by the PDCCH repetitions. For example, the parameter may be configured/indicated via any of RRC signaling, MAC CE and DCI. In some embodiments, the parameter may be combined with the counter DAI value and/or the total DAI value to indicate the order and/or the position of the feedback field in the feedback sequence. For example, the order and/or the position of the feedback field in the feedback sequence may be the same for the PDSCH or SPS PDSCH release scheduled by the PDCCH repetitions.

FIG. 8 illustrates a flowchart of an example method 800 in accordance with some embodiments of the present disclosure. The method 800 can be performed at the network device 110 as shown in FIG. 1 and/or FIG. 2. It is to be understood that the method 800 may include additional blocks not shown and/or may omit some blocks as shown, and the scope of the present disclosure is not limited in this regard.

At block 810, the network device 110 transmits, to the terminal device 120, a plurality of PDCCH repetitions for scheduling downlink transmissions, where at least a part of the plurality of PDCCH repetitions indicate a same counter DAI value.

At block 820, the network device 110 performs, based on the plurality of PDCCH repetitions, the downlink transmissions from the network device 110 to the terminal device 120.

At block 830, the network device 110 receives a feedback sequence for the downlink transmissions from the terminal device 120, where the at least a part of the plurality of PDCCH repetitions correspond to a same feedback field in the feedback sequence.

In some embodiments, the plurality of PDCCH repetitions may comprise a first set of PDCCH repetitions corresponding to a first set of total DAI values and a second set of PDCCH repetitions corresponding to a second set of total DAI values independent of the first set of total DAI values. The network device 110 may transmit, to the terminal device 120, the first set of PDCCH repetitions and the second set of PDCCH repetitions indicating a same counter DAI value.

In some embodiments, the first set of PDCCH repetitions and the second set of PDCCH repetitions may correspond to a first feedback field in the feedback sequence. In response to receiving the feedback sequence from the terminal device 120, the network device 110 may determine, from the first feedback field, a result of decoding at least one downlink transmission scheduled by the first set of PDCCH repetitions and the second set of PDCCH repetitions.

In some embodiments, the plurality of PDCCH repetitions may comprise a first set of PDCCH repetitions corresponding to a first set of total DAI values and a second set of PDCCH repetitions corresponding to a second set of total DAI values independent of the first set of total DAI values. The network device 110 may transmit, to the terminal device 120, the first set of PDCCH repetitions indicating a first counter DAI value and the second set of PDCCH repetitions indicating a second counter DAI value independent of the first counter DAI value.

In some embodiments, the first set of PDCCH repetitions may correspond to a first feedback field in the feedback sequence and the second set of PDCCH repetitions may correspond to a second feedback field different from the first feedback field in the feedback sequence. In response to receiving the feedback sequence from the terminal device 120, the network device 110 may determine, from the first feedback field, a first result of decoding at least one downlink transmission scheduled by the first set of PDCCH repetitions; and determine, from the second feedback field, a second result of decoding at least one downlink transmission scheduled by the second set of PDCCH repetitions.

In some embodiments, the network device 110 may transmit, to the terminal device 120, the plurality of PDCCH repetitions indicating different total DAI values respectively.

In some embodiments, a PDCCH repetition of the plurality of PDCCH repetitions may comprise a first field for indicating a counter DAI value and a second field for indicating a total DAI value. The network device 110 may generate the PDCCH repetition by indicating an index of the PDCCH repetition within the plurality of PDCCH repetitions in the first field and indicating the number of the plurality of PDCCH repetitions in the second field; and transmit the PDCCH repetition to the terminal device 120.

In some embodiments, prior to transmitting the plurality of PDCCH repetitions, the network device 110 may transmit, to the terminal device 120, a configuration indicative of whether PDCCH signals sharing a same counter DAI value across different sets of total DAI values are repeated or not.

FIG. 9 illustrates a flowchart of an example method 900 in accordance with some embodiments of the present disclosure. The method 800 can be performed at the terminal device 120 as shown in FIG. 1 and/or FIG. 2. It is to be understood that the method 900 may include additional blocks not shown and/or may omit some blocks as shown, and the scope of the present disclosure is not limited in this regard.

At block 910, the terminal device 120 receives, from the network device 110, a plurality of PDCCH repetitions for scheduling downlink transmissions, where at least a part of the plurality of PDCCH repetitions indicate a same counter DAI value.

At block 920, the terminal device 120 decodes, based on the plurality of PDCCH repetitions, the downlink transmissions from the network device 110.

At block 930, the terminal device 120 transmits, based on the decoding of the downlink transmissions, a feedback sequence to the network device 110, where the at least a part of the plurality of PDCCH repetitions correspond to a same feedback field in the feedback sequence.

In some embodiments, the plurality of PDCCH repetitions may comprise a first set of PDCCH repetitions corresponding to a first set of total DAI values and a second set of PDCCH repetitions corresponding to a second set of total DAI values independent of the first set of total DAI values. The terminal device 120 may receive, from the network device 110, the first set of PDCCH repetitions and the second set of PDCCH repetitions indicating a same counter DAI value.

In some embodiments, the network device 110 may determine, from the feedback sequence and based on the same counter DAI value, a first feedback field corresponding to the first set of PDCCH repetitions and the second set of PDCCH repetitions; indicate a result of decoding at least one downlink transmission scheduled by the first set of PDCCH repetitions and the second set of PDCCH repetitions in the first feedback field; and transmit, to the network device 110, the feedback sequence indicating the result.

In some embodiments, the plurality of PDCCH repetitions may comprise a first set of PDCCH repetitions corresponding to a first set of total DAI values and a second set of PDCCH repetitions corresponding to a second set of total DAI values independent of the first set of total DAI values. The terminal device 120 may receive, from the network device 110, the first set of PDCCH repetitions indicating a first counter DAI value and the second set of PDCCH repetitions indicating a second counter DAI value independent of the first counter DAI value.

In some embodiments, the terminal device 120 may determine, from the feedback sequence and based on the first counter DAI value, a first feedback field corresponding to the first set of PDCCH repetitions and determine, from the feedback sequence and based on the second counter DAI value, a second feedback field corresponding to the second set of PDCCH repetitions, where the first feedback field is different from the second feedback field. The terminal device 120 may indicate a first result of decoding at least one downlink transmission scheduled by the first set of PDCCH repetitions in the first feedback field and a second result of decoding at least one downlink transmission scheduled by the second set of PDCCH repetitions in the second feedback field, and transmit the feedback sequence indicating the first and second results to the network device.

In some embodiments, the terminal device 120 may receive the plurality of PDCCH repetitions indicating different total DAI values respectively.

In some embodiments, a PDCCH repetition of the plurality of PDCCH repetitions may comprise a first field for indicating a counter DAI value and a second field for indicating a total DAI value. In response to receiving the PDCCH repetition from the network device 110, the terminal device 120 may determine, from the first field of the received PDCCH repetition, an index of the PDCCH repetition within the plurality of PDCCH repetitions and determine, from the second field of the received PDCCH repetition, the number of the plurality of PDCCH repetitions.

In some embodiments, prior to receiving the plurality of PDCCH repetitions, the terminal device 120 may receiving, from the network device 110, a configuration indicative of whether PDCCH signals sharing a same counter DAI value across different sets of total DAI values are repeated or not.

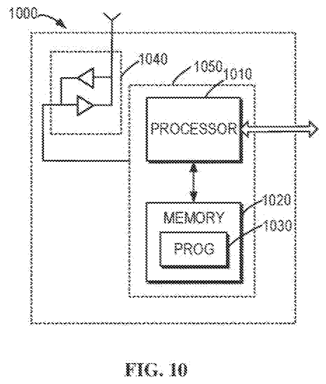

FIG. 10 is a simplified block diagram of a device 1000 that is suitable for implementing embodiments of the present disclosure. The device 1000 can be considered as a further example implementation of the network device 110, the terminal device 120 or the TRP 130 as shown in FIG. 1 and/or FIG. 2. Accordingly, the device 1000 can be implemented at or as at least a part of the network device 110, the terminal device 120 or the TRP 130 as shown in FIG. 1 and/or FIG. 2.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 8 and/or FIG. 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
transmitting, from a network device to a terminal device, a plurality of PDCCH repetitions for scheduling downlink transmissions, wherein at least a part of the plurality of PDCCH repetitions indicate a same counter downlink assignment indicator (DAI) value;
performing, based on the plurality of PDCCH repetitions, the downlink transmissions from the network device to the terminal device; and
receiving a feedback sequence for the downlink transmissions from the terminal device, wherein the at least a part of the plurality of PDCCH repetitions correspond to a same feedback field in the feedback sequence.

2. The method of claim 1, wherein the plurality of PDCCH repetitions comprise a first set of PDCCH repetitions corresponding to a first set of total DAI values and a second set of PDCCH repetitions corresponding to a second set of total DAI values independent of the first set of total DAI values, and transmitting the plurality of PDCCH repetitions comprises:
transmitting, to the terminal device, the first set of PDCCH repetitions and the second set of PDCCH repetitions indicating a same counter DAI value.

3. The method of claim 2, wherein the first set of PDCCH repetitions and the second set of PDCCH repetitions correspond to a first feedback field in the feedback sequence, and the method further comprises:
in response to receiving the feedback sequence from the terminal device,
determining, from the first feedback field, a result of decoding at least one downlink transmission scheduled by the first set of PDCCH repetitions and the second set of PDCCH repetitions.

4. The method of claim 1, wherein the plurality of PDCCH repetitions comprise a first set of PDCCH repetitions corresponding to a first set of total DAI values and a second set of PDCCH repetitions corresponding to a second set of total DAI values independent of the first set of total DAI values, and transmitting the plurality of PDCCH repetitions comprises:
transmitting, to the terminal device, the first set of PDCCH repetitions indicating a first counter DAI value and the second set of PDCCH repetitions indicating a second counter DAI value independent of the first counter DAI value.

5. The method of claim 4, wherein the first set of PDCCH repetitions correspond to a first feedback field in the feedback sequence and the second set of PDCCH repetitions correspond to a second feedback field different from the first feedback field in the feedback sequence, and the method further comprises:
in response to receiving the feedback sequence from the terminal device,
determining, from the first feedback field, a first result of decoding at least one downlink transmission scheduled by the first set of PDCCH repetitions; and
determining, from the second feedback field, a second result of decoding at least one downlink transmission scheduled by the second set of PDCCH repetitions.

6. The method of claim 1, wherein transmitting the plurality of PDCCH repetitions comprises:
transmitting, to the terminal device, the plurality of PDCCH repetitions indicating different total DAI values.

7. The method of claim 1, wherein a PDCCH repetition of the plurality of PDCCH repetitions comprises a first field for indicating a counter DAI value and a second field for indicating a total DAI value, and transmitting the plurality of PDCCH repetitions comprises:
generating the PDCCH repetition by indicating an index of the PDCCH repetition within the plurality of PDCCH repetitions in the first field and indicating the number of the plurality of PDCCH repetitions in the second field; and
transmitting the PDCCH repetition to the terminal device.

8. The method of any of claims 2-5, further comprising:
transmitting, to the terminal device, a configuration indicative of whether PDCCH signals sharing a same counter DAI value across different sets of total DAI values are repeated or not.

9. A method of communication, comprising:
receiving, at a terminal device and from a network device, a plurality of PDCCH repetitions for scheduling downlink transmissions, wherein at least a part of the plurality of PDCCH repetitions indicate a same counter downlink assignment indicator (DAI) value;
decoding, based on the plurality of PDCCH repetitions, the downlink transmissions from the network device; and
transmitting, based on the decoding of the downlink transmissions, a feedback sequence to the network device, wherein the at least a part of the plurality of PDCCH repetitions correspond to a same feedback field in the feedback sequence.

10. The method of claim 9, wherein the plurality of PDCCH repetitions comprise a first set of PDCCH repetitions corresponding to a first set of total DAI values and a second set of PDCCH repetitions corresponding to a second set of total DAI values independent of the first set of total DAI values, and receiving the plurality of PDCCH repetitions comprises:
receiving, from the network device, the first set of PDCCH repetitions and the second set of PDCCH repetitions indicating a same counter DAI value.

11. The method of claim 10, wherein transmitting the feedback sequence to the network device comprises:
determining, from the feedback sequence and based on the same counter DAI value, a first feedback field corresponding to the first set of PDCCH repetitions and the second set of PDCCH repetitions;
indicating a result of decoding at least one downlink transmission scheduled by the first set of PDCCH repetitions and the second set of PDCCH repetitions in the first feedback field; and
transmitting, to the network device, the feedback sequence indicating the result.

12. The method of claim 9, wherein the plurality of PDCCH repetitions comprise a first set of PDCCH repetitions corresponding to a first set of total DAI values and a second set of PDCCH repetitions corresponding to a second set of total DAI values independent of the first set of total DAI values, and receiving the plurality of PDCCH repetitions comprises:
receiving, from the network device, the first set of PDCCH repetitions indicating a first counter DAI value and the second set of PDCCH repetitions indicating a second counter DAI value independent of the first counter DAI value.

13. The method of claim 12, wherein transmitting the feedback sequence to the network device comprises:
determining, from the feedback sequence and based on the first counter DAI value, a first feedback field corresponding to the first set of PDCCH repetitions;
determining, from the feedback sequence and based on the second counter DAI value, a second feedback field corresponding to the second set of PDCCH repetitions, wherein the first feedback field is different from the second feedback field;
indicating a first result of decoding at least one downlink transmission scheduled by the first set of PDCCH repetitions in the first feedback field and a second result of decoding at least one downlink transmission scheduled by the second set of PDCCH repetitions in the second feedback field; and
transmitting the feedback sequence indicating the first and second results to the network device.

14. The method of claim 9, wherein receiving the plurality of PDCCH repetitions comprises:
receiving the plurality of PDCCH repetitions indicating different total DAI values.

15. The method of claim 9, wherein a PDCCH repetition of the plurality of PDCCH repetitions comprises a first field for indicating a counter DAI value and a second field for indicating a total DAI value, and the method further comprises:
in response to receiving the PDCCH repetition from the network device,
determining, from the first field of the received PDCCH repetition, an index of the PDCCH repetition within the plurality of PDCCH repetitions; and
determining, from the second field of the received PDCCH repetition, the number of the plurality of PDCCH repetitions.

16. The method of any of claims 9-13, further comprising:
receiving, from the network device, a configuration indicative of whether PDCCH signals sharing a same counter DAI value across different sets of total DAI values are repeated or not.

17. A network device, comprising:
a processor; and
a memory coupled to the processor and storing instructions thereon, the instructions, when executed by the processor, causing the network device to perform the method according to any of claims 1 to 8.

18. A terminal device, comprising:
a processor; and
a memory coupled to the processor and storing instructions thereon, the instructions, when executed by the processor, causing the terminal device to perform the method according to any of claims 9 to 16.

19. A computer readable medium having instructions stored thereon, the instructions, when executed on at least one processor, causing the at least one processor to perform the method according to any of claims 1 to 8.

20. A computer readable medium having instructions stored thereon, the instructions, when executed on at least one processor, causing the at least one processor to perform the method according to any of claims 9 to 16.
